(19) United States
(12) Patent Application Publication
(10) Pub. No.: US 2024/0013318 A1
(43) Pub. Date: Jan. 11, 2024

(54) CATALOG BASED EMBEDDINGS MODEL

(71) Applicant: eBay Inc., San Jose, CA (US)

(72) Inventors: Stephanie Michelle MOYERMAN, Phoenix, AZ (US); Alok Bhushan LAL, San Jose (US); Yang ZHAO, Shanghai (CN); Somasekhr KORAPATI, San Ramon (US); Wei MIN, Shanghai (CN); Weiming LIANG, Shanghai (CN); Zhichao HAN, Shanghai (CN); Ramkumar GOLLAMUDI, San Jose (US); Manohar ELLANTI, Fremont (US); Zitao ZHANG, Shanghai (CN); Tarunkumar Venkata PASUMARTHI, Fremont (US); Sanyasi Naidu SINGAMPALLI, Livermore (US); Srihita RAMANAN, Milpitas (US); Neetika SRIVASTAVA, San Jose (US); Devendrakumar TRIPATHI, San Jose (US)

(21) Appl. No.: 17/858,841

(22) Filed: Jul. 6, 2022

(51) Int. Cl. G06Q 40/00; G06N 5/02

(52) U.S. Cl. CPC G06Q 40/123; G06N 5/022

(57) ABSTRACT

A tax category prediction model, which is trained using a tax category prediction dataset, provides a tax category prediction for an item having an item listing. The tax category prediction model enhances the ability and accuracy of identifying a tax category associated with an item for sale via the online marketplace (e.g., identifying the tax category before the item is offered for sale via the online marketplace). The tax category prediction dataset is generated based on one or more of a text embedding, an image embedding, another type of embedding, or a combination thereof. The text embedding may be identified by applying a natural language processing model to a text string of the item listing. The natural language processing model may comprise bidirectional encoder representations from transformers (BERT).

### BACKGROUND

Availability of the Internet has encouraged both consumers and sellers to engage in increasing numbers of electronic transactions. In ecommerce, sellers are required to charge location-specific taxes on purchased goods and services. Tax planning (for the location-specific taxes) by sellers (e.g., individuals or companies) can be based on various tax forecasting methods, but can be difficult to forecast because of the vast amount of data stored in electronic catalogs. Tax revenue from ecommerce transactions is a condition to ensure healthy operation of a market economy and promotes the continuous progress of society. Accurate tax planning by sellers enhances the operation of the market economy by allowing sellers to manage their catalogs and transaction associated with the market.

### SUMMARY

At a high level, aspects described herein relate to generating a catalog based embedding model, such as a tax category prediction model. A tax category prediction dataset may be generated for training the tax category prediction model based in part on identifying a text embedding within each of a plurality of item listings using a natural language processing model (e.g., a natural language processing model comprising bidirectional encoder representations from transformers). Each of the plurality of item listings may be associated with one or more items that correspond to one or more categories. The natural language processing model may be trained on an item listing dataset of an item listing database.

Further, each text embedding identified may be associated with a title of each of the plurality of item listings (e.g., a text embedding generated at least partially from the title of an item listing, such as a description, for a good or service). In some embodiments, the text embedding may additionally or alternatively be associated with another item listing feature (e.g., a brand). Each text embedding may be mapped to one or more predetermined tax categories for the generation of the tax category prediction dataset. Upon generating the tax category prediction dataset, the tax category prediction dataset may be used to train the tax category prediction model.

One method involves the tax category prediction model receiving a first text embedding from a first item listing of a first item. Based on receiving the first text embedding, the trained tax category prediction model provides a tax category prediction for the first item listing based on the first text embedding.

In some embodiments, each of the plurality of item listings comprise one or more images. As such, an image embedding may be generated for the one or more images for one or more of the plurality of item listings. The image embeddings may be mapped to the one or more predetermined tax categories to further generate the tax category prediction dataset, which is then used to train the tax category prediction model. The tax category prediction model may then receive the first text embedding and a first image embedding of a first image from the first item listing. In response, the tax category prediction model provides the tax category prediction for the first item listing based on receiving the first text embedding and the first image embedding.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 block diagram of an example operating environment suitable for employing a tax category prediction engine, in accordance with an embodiment described herein;

FIG. 2 is another example operating environment suitable for employing the tax category prediction engine, in accordance with an embodiment described herein;

FIG. 3 is a block diagram of an example flow diagram for generating a text embedding and an image embedding for an item listing of an item, in accordance with an embodiment described herein;

FIG. 4 is flow diagram illustrating an example method for providing a tax category prediction for an item listing, in accordance with an embodiment described herein;

FIG. 5 is another flow diagram illustrating an example method for providing a tax category prediction for an item listing, in accordance with an embodiment described herein;

FIG. 6 is a table illustrating an example tax category prediction dataset suitable for training a tax category prediction model, in accordance with an embodiment described herein;

FIG. 7 is a flowchart illustrating an example method for providing a tax category prediction for an item listing, in accordance with an embodiment described herein; and

FIG. 8 is an example computing device suitable for implementing the described technology, in accordance with an embodiment described herein.

### DETAILED DESCRIPTION

Tax planning, by ecommerce sellers (e.g., individuals or companies) required to charge location-specific taxes on purchased goods and services, can be based on various tax modeling methods. Some tax modeling methods may occasionally fail to align the purchased good or service in the seller's catalog to the appropriate tax category. For example, the logic used in the prior tax modeling methods might misclassifying the appropriate tax category, since the logic does not directly associate items in the catalog to the proper tax category definitions. Continuing the example, category definitions of items in the catalog (e.g., leaf categories) frequently change, and the prior tax modeling methods might not incorporate the definition change into the logic or improperly incorporate the definition change into the logic. In addition, tax category definitions also change, and the prior tax modeling methods might not incorporate or improperly incorporate the tax category definition change into the logic.

Further, the electronic nature of ecommerce may provide avenues for non-compliance with taxation schemes. For example, a taxpayer may unintentionally categorize a good or service for taxation purposes based on prior tax modeling methods failing to accurately determine the proper tax for the good or service. For example, the prior tax modeling methods (e.g., those using image recognition), may improperly classify a book about wine as a wine instead of a book for tax purposes, thereby inadvertently collecting an additional alcohol tax on sale of the book. As another example, the prior tax modeling methods may improperly classify a miniature toy bed as a mattress instead of a toy; or a grooming/hygiene product as an alcoholic beverage or cleaning product.

Additionally, some of the previous tax modeling methods analyze file-based inputs that include terms that are not associated with a proper tax classification of the good or service. Further, rather than using real-time application programming interface (API) data, the previous tax modeling methods use the file-based inputs, and this causes delayed processing due to the increased time difference between the time at which the file-based inputs were listed and the time at which a prior tax model could provide a prediction using the file-based inputs. As such, in addition to the misclassifications for taxation by the prior systems based on errors in matching catalog data with the proper taxation definitions, the prior systems might also provide delayed predictions as a result of using the file-based inputs. One result of providing delayed predictions is that sellers are not able to receive the taxation predictions by the prior systems prior to offering a good or service on the online marketplace.

These shortcomings of existing tax modeling methods adversely affect computer network communications. For example, each time a catalog item is classified, contents or payload of the classification (e.g., payload associated with metadata from a file-based input) is multiplied by all the additional processing needed to analyze the file-based input. As such, there are throughput and latency costs corresponding to generating this metadata and sending it over a computer network. In some instances, these file-based inputs increase storage device I/O (e.g., excess physical read/write head movements on non-volatile disk) because each time unnecessary information (e.g., unnecessary and excessive catalog data, improper taxation definitions, etc.) is processed, the computing system often has to reach out to the storage device to perform a read or write operation, which is time consuming, error prone, and can eventually wear on components, such as a read/write head.

Furthermore, some prior system architectures include classifiers that have not been trained on particular features within an item listing of a catalog. For example, the prior systems may only be trained on identifying whether or not a seller-provided description of a good or service listed on the market includes or does not include a particular term (such as whether or not the term “book” is within the description). More specifically, the prior system architectures are not trained on particular textual embeddings; and the prior systems do not generate any particular textual embeddings from the seller descriptions of the good or service. In addition, some prior system architectures do not use any images (e.g., seller-provided images) during classification. As a result, these prior systems might mischaracterize an item when providing the taxation predictions for offered goods or services, since particular data (e.g., a particular textual embedding or a particular image embedding) might not be analyzed by these prior systems.

As such, it is a goal of some online marketplaces to more accurately identify and determine tax category predictions for item listings for goods or services, for example. Another goal of the online marketplaces also includes identifying and determining the tax category prediction early enough so that the seller can have this information before listing the item listing on the online marketplace. In addition, it is beneficial to provide a system that rapidly responds to changes in the online marketplace, such as new items and new item listings that are continuously introduced.

The technology described by this disclosure achieves these goals and provides a solution to the problems specific to online marketplaces discussed above. In particular, the present disclosure generally describes a system for providing a tax category prediction for an item (such as a good or service, for example) having an item listing by using an enhanced tax category prediction model, which is trained using a tax category prediction dataset. The tax category prediction dataset may be generated by identifying a text embedding within one or more item listings (e.g., item listings from real-time API data). For example, a natural language processing model (e.g., a natural language processing model comprising bidirectional encoder representations from transformers) may be applied to a text string within the item listing. By generating the tax category prediction dataset based on identifying the text embedding, tax category predictions are enhanced and have a higher accuracy than some prior systems that fail to identify and analyze particular textual embeddings.

In some embodiments, each text embedding identified, for generating the tax category prediction dataset, may be associated with a title of an item listing. Further, the tax category prediction dataset is generated by mapping each text embedding to one or more predetermined tax categories. By generating the tax category prediction dataset based on generating particular text embeddings for titles of item listings and mapping those text embeddings to the predetermined tax categories, the technology described herein is capable of providing tax category predictions that are enhanced and have a higher accuracy than the prior systems that fail to identify and analyze particular textual embeddings.

Upon generating the tax category prediction dataset, the tax category prediction model is trained using the generated tax category prediction dataset. The trained tax category prediction model receives a first text embedding from a first item listing of a first item. Based on receiving the first text embedding, the trained tax category prediction model provides a tax category prediction for the first item listing based on the first text embedding. In aspects, the tax category prediction may be provided prior to the first item being listed for sale on the online marketplace. For example, an instruction may be transmitted to a user device associated with the seller to display a graphical user interface including a price associated with the tax category prediction for the first item.

Additionally, the tax category prediction model may be further trained based on a detected change associated with an item listing used to generate the tax category prediction dataset, a detected change associated with the first item listing corresponding to the first text embedding, a detected change associated with the one or more predetermined tax categories, or a detected change (e.g., a user-based selection) from the tax category prediction provided for display on the graphical user interface of the user device. Continuing the example, a user-based selection may be received by the user device, such that the tax category prediction is changed to another tax category for the first item. Upon further training the tax category prediction model based on the detected change, another tax category prediction may be provided by the trained tax category prediction model in response to receiving another text embedding. As such, the tax category prediction model is further enhanced by automatically detecting and updating based on instantaneous changes that are incorporated into the system for precise and accurate tax category predictions.

Furthermore, the tax category prediction model may be trained based on one or more images from one or more item listings. For example, one or more image embeddings may be generated for one or more images of an item listing. In addition, the one or more image embeddings may be concatenated with a corresponding text embedding for the item listing. The concatenated image-text embedding may be mapped to the one or more predetermined tax categories to further generate the tax category prediction dataset. As such, the tax category prediction model may be trained on the tax category prediction dataset that comprises the concatenated image-text embedding that is mapped to the one or more predetermined tax categories. Upon receiving a first text embedding and a first image embedding for a first item listing, the trained tax category prediction model may provide a tax category prediction for the first item listing.

As such, by training the tax category prediction model for receiving a text embedding from an item listing of an item, the technology disclosed herein provides a faster and more computationally efficient method compared to existing tax modeling methods that have not been trained on particular features within an item listing of a catalog. Additionally, the technology disclosed herein provides a faster and more computationally efficient method compared to the existing tax modeling methods that increase the contents or payload of the classification (e.g., payload associated with metadata from a file-based input) based on all the additional processing needed to analyze the file-based input. For example, unlike the existing tax modeling methods that provide delayed predictions to sellers, the technology described by this disclosure is able to provide taxation predictions to sellers prior to the seller offering a good or service on the online marketplace. As another example, the technology described by this disclosure reduces throughput and latency costs by using real-time API data and by reducing the processing of excessive catalog data, thereby allowing the computing system to operate without excessive performance of read or write operations. As such, the technology described by this disclosure reduces time consuming and error prone processing and reduces wear on components.

Having provided some example scenarios, a technology suitable for performing these examples is described in more detail with reference to the drawings. It will be understood that additional systems and methods for providing tax category predictions for an item can be derived from the following description of the technology.

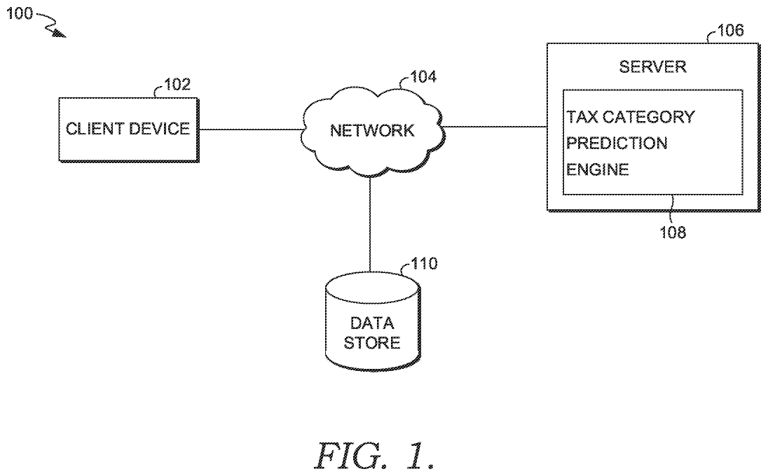

Turning now to FIG. 1, FIG. 1 illustrates a block diagram of example operating environment 100 in which implementations of the present disclosure may be employed. In particular, FIG. 1 illustrates a high-level architecture of operating environment 100 having components in accordance with implementations of the present disclosure. The components and architecture of FIG. 1 are intended as examples, as noted toward the end of the Detailed Description.

Among other components or engines not shown, operating environment 100 includes client device 102. Client device 102 is shown communicating using network 104 to server 106 and data store 110. Server 106 is illustrated as hosting aspects of tax category prediction engine 108.

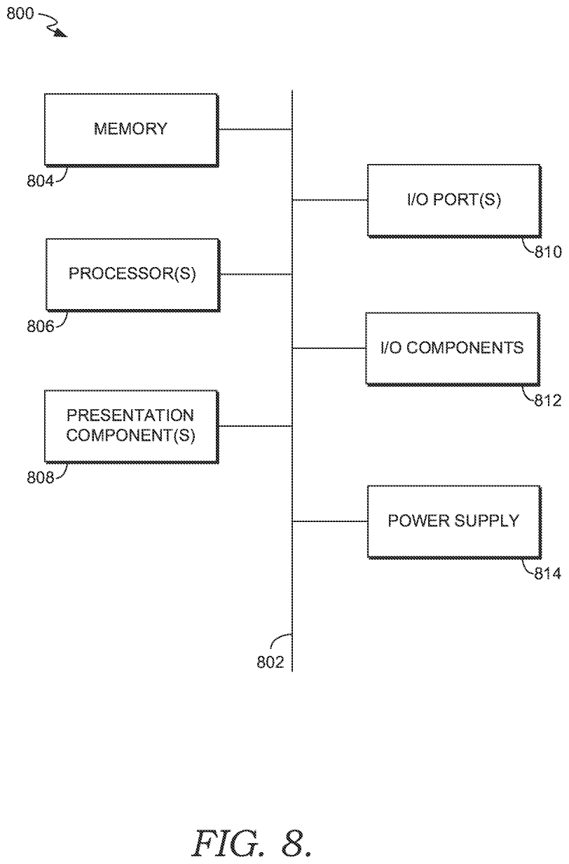

The client device 102 may be any type of computing device. One such example is computing device 800 described with reference to FIG. 8. Broadly, however, client device 102 can include computer-readable media storing computer-executable instructions executed by at least one computer processor.

Client device 102 may be operated (e.g., by a person, robot, or other entity) that interacts with server 106 to employ aspects of the tax category prediction engine 108. Some example devices suitable for use as client device 102 include a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

Client device 102 can employ computer-executable instructions of an application, which can be hosted in part or in whole at client device 102, or remote from client device 102. That is, the instructions can be embodied on one or more applications. An application is generally capable of facilitating the exchange of information between components of operating environment 100. The application may be embodied as a web application that runs in a web browser. This may be hosted at least partially on a server-side of operating environment 100. The application can comprise a dedicated application, such as an application having analytics functionality. In some cases, the application is integrated into the operating system (e.g., as a service or program). It is contemplated that “application” be interpreted broadly.

As illustrated, components or engines of operating environment 100, including client device 102, may communicate using network 104. Network 104 can include one or more networks (e.g., public network or virtual private network “VPN”) as shown with network 104. Network 104 may include, without limitation, one or more local area networks (LANs) wide area networks (WANs), or any other communication network or method.

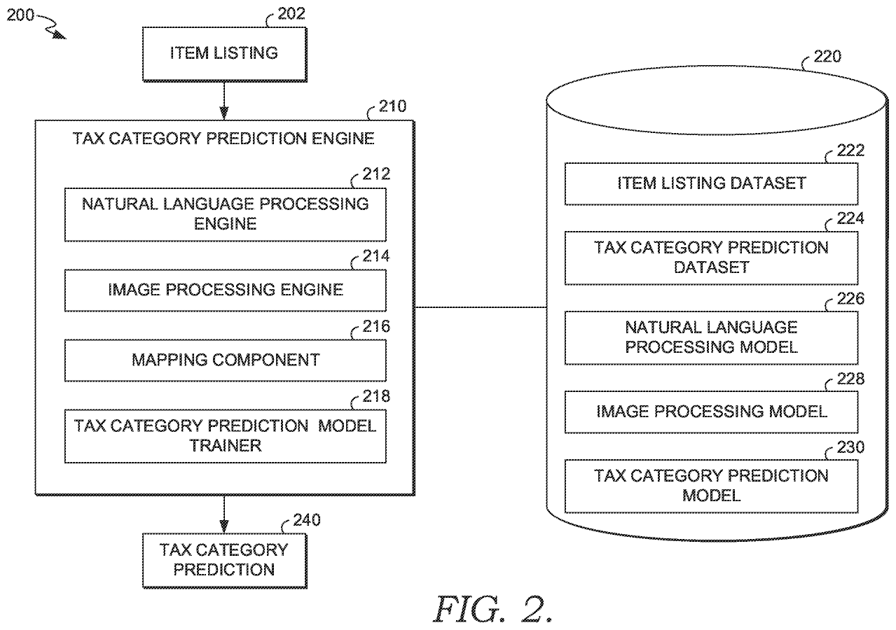

Server 106 generally supports the tax category prediction engine 108. Server 106 includes one or more processors, and one or more computer-readable media. One example server suitable for use is provided by aspects of computing device 800 of FIG. 8. Additionally, the computer-readable media includes computer-executable instructions executable by the one or more processors. The instructions may optionally implement one or more components of the tax category prediction engine 108, which will be described in additional detail below with reference to FIG. 2. As with other components of FIG. 1, while server 106 is illustrated a single server, it can include one or more servers, and various components of server 106 can be locally integrated within the one or more servers or may be distributed in nature.

Operating environment 100 is shown having data store 110. Data store 110 generally stores information including data, computer instructions (e.g., software program instructions, routines, or services), or models used in embodiments of the described technologies. Although depicted as a single component, data store 110 may be embodied as one or more data stores or may be in the cloud. One example of data store 110 includes memory 804 of FIG. 8.

Having identified various components of operating environment 100, it is noted that any number of components may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Further, although some components of FIG. 1 are depicted as single components, the depictions are intended as examples in nature and in number and are not to be construed as limiting for all implementations of the present disclosure. Other arrangements and elements (e.g., machines, interfaces, functions, orders, and groupings of functions, etc.) can be used in addition to or instead of those shown, and some elements may be omitted altogether. Thus, it is reiterated that the operating environment 100 is but one example. In another example, functions of tax category prediction engine 108 are performed at client device 102, while in another example, one or more functions of tax category prediction engine 108 are performed at client device 102 along with one or more functions being performed by server 106 in any combination. All such embodiments are intended to be within the scope of this disclosure.

With regard to FIG. 2, an example tax category prediction environment 200 is provided. Example tax category prediction engine 210 of environment 200 is suitable for use as the tax category prediction engine 108 of FIG. 1. Many of the elements described in relation to FIG. 2 are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory.

As illustrated in FIG. 2, example environment 200 includes tax category prediction engine 210. At a high level, the tax category prediction engine 210 generates and provides tax category prediction 240 based on receiving item listing 202. To do so, tax category prediction engine 210 employs natural language processing engine 212, image processing engine 214, mapping component 216, and tax category prediction model trainer 218.

As illustrated in example environment 200, the tax category prediction engine 210 communicates with data store 220. Data store 220 is the type of data store described with respect to data store of FIG. 1. Data store 220 is illustrated in example environment 200 as including item listing dataset 222, tax category prediction dataset 224, natural language processing model 226, image processing model 228, and tax category prediction model 230. The data illustrated within data store 220 is illustrated as an example. More or less data elements (e.g., only data elements 224, 226, and 230, for example; or an additional data element not depicted), or one or more combinations of data elements thereof may be used by tax category prediction engine 210 in some embodiments. In some embodiments, the data elements of data store 220 are distributed between or among a plurality of data stores, for example. The data elements shown in FIG. 2 have been provided to describe one example that can be implemented using the described technology.

Item listing 202 may be received by tax category prediction engine 210. For example, the item listing 202 may provide data (e.g., a description) for an item (e.g., a good or service). An item may, for example, be tangible (e.g., a deck of cards), intangible (e.g., software), or something that has a distinct and separate existence from other things (e.g., a subscription to an audible book collection for a period of time). In another case, the items listing comprises data describing a service. Further, an item listing, such as item listing 202, may include a description of the item available on a network-based marketplace. For example, the description of the item may include a condition of the item, one or more ratings of the item (e.g., ratings provided by an online marketplace user or buyer), a pattern on the item, an identifier for the item (e.g., a batch number, a catalog number, a serial number, a part number), a brand, a style, a size, a seller identifier (e.g., a unique identifier associated with a particular seller), a color, an available quantity, a price (e.g., list price, sale price, current auction price, current bid price), a number of the items previously sold, other suitable description information (e.g., other suitable description information related to sale, purchase, or user-interaction with the item listing), or a combination thereof.

Upon receipt of the item listing 202 by the tax category prediction engine 210, natural language processing (NLP) engine 212 may process the item listing 202 to identify or extract data. NLP engine 212 may receive one or more text characters (e.g., a Latin alphabet letter or number, an Arabic alphabet letter or number, a Roman numeral, another symbol) or text strings comprising more than one text character, from the item listing 202. The NLP engine 212 may process the one or more text characters or the one or more text strings as needed, and store the processed one or more text characters or the processed one or more text strings (e.g., within the item listing dataset 222) in data store 220. The item listing may be received from an entity, such as a third-party seller, a consumer, one or more online marketplaces, a manufacturer, a retailer, a collector, an item expert, a website, another entity, or the like, or a combination thereof.

NLP engine 212 can be applied to process structured, semi-structured, or unstructured data of the item listing 202. Structured data includes data that is organized in some scheme that allows the data to be easily exported and indexed as item listing dataset 222. Structured data can generally be collected and rearranged to comport to the index of item data within the item listing dataset 222. Unstructured data is not organized in a pre-defined manner and may include text, dates, numbers, facts, and so-forth. Unstructured data may sometimes require additional processing (compared to the processing of structured data) to store it in a computer-useable format within the item listing dataset 222. Semi-structured data does not conform to a data model but has some structure (e.g., more structure than the unstructured data) or some organizational properties. In some embodiments, structured, semi-structured, or unstructured item data, can include an online conversation, stored chatbot information, a manufacture's specification, item inspection notes, expert opinions, item packaging, general communications, books, articles, presentations, another medium through which information is conveyed, or a combination thereof.

To process the data of the item listing 202, NLP engine 212 is generally applied to textual data within the item listing 202. For audio and video data, a speech-to-text software can be employed to convert audio and video data into textual data for further processing by the NLP engine 212. One example of a speech-to-text software that is suitable for use with the current technology is Microsoft's Azure Speech to Text. Other speech-to-text software may also be suitable for use.

The item listing dataset 222 may be used to train the NLP engine 212. For example, the item listing dataset 222 may include item listing titles from a plurality of item listings. Continuing the example, one or more keywords may be identified for each item listing title. In some aspects, the NLP engine 212 is applied to one or more particular text characters or one or more particular text strings of the item listing titles. In some aspects, the item listing titles are processed in real-time (e.g., as an item listing title is received). In some aspects, the item listing titles are processed in response to receiving a new item listing title or in response to detecting a change to an item listing title. In some embodiments, one or more item listing datasets 222 are generated based on an identified keyword associated with a particular category (e.g., grooming and hygiene, mattresses, toys).

Additionally or alternatively, the item listing dataset 222 may include item listing descriptions from a plurality of item listings. For example, an extracted item listing description may include a particular identifier for the item (e.g., a batch number, a catalog number, a serial number, a part number), a brand, a seller identifier (e.g., a unique identifier associated with a particular seller), a quantity, a price, another item listing description, or a combination thereof. In some aspects, the NLP engine 212 is applied to one or more particular text characters or one or more particular text strings of the item listing description and title. In some aspects, the item listing descriptions are processed in real-time or in response to receiving a new item listing description, a new portion of the item listing description, or in response to detecting another type of change to the item listing description. In some embodiments, item listing dataset 222 is generated based on an identified keyword (e.g., a particular identifier for the item, a particular seller identifier) within the item listing description, the keyword being associated with a particular category (e.g., grooming and hygiene, mattresses, toys).

The NLP engine 212 may be trained on an extracted item listing title, an extracted portion of the item listing title, an extracted item listing description (e.g., seller identifier), an extracted keyword, or a combination thereof, to identify a text embedding to generate one or more item listing datasets. In some embodiments, item listing dataset 222 is generated and stored at data store 220 based on a particular client or entity (e.g., a particular company or a particular department of the company). As such, the NLP engine 212 may be trained specifically for the particular client or entity based on the particular item listings for that particular client or entity. For example, a particular client or entity may use a different nomenclature or may have an item listing structure different than another client or entity; and training the NLP engine 212 for the particular client or entity would enhance the efficiency and accuracy of the NLP engine 212 for that particular client or entity. In the examples provided throughout this disclosure, training may include aspects of fine tuning a pretrained model.

In some embodiments, item listing dataset 222 are organized prior to training the NLP engine 212 using the item listing dataset 222. For example, the item listing dataset 222 may be organized based on a category (e.g., dresses, jewelry) identified from the extracted item listing title or portion of the item listing title, the extracted item listing description (e.g., an item identifier), the extracted keyword associated with the title or description, or combination thereof. Additionally or alternatively, the item listing dataset 222 may be organized based on a recall number associated with the respective item listing, a number of purchases associated with the respective item listing, a purchaser-provided ranking of the respective item listing, a number of views of the respective item listing, an amount of taxes paid by the purchasers of the respective item listing, another item listing indictor, or a combination thereof. Accordingly, the natural language processing model 226 employed by the NLP engine 212 may be trained using the organized item listing dataset 222. The natural language processing model 226 is trained to determine text embedding from a text string of the item listing.

The NLP engine 212 employs the NLP model 226 to determine text embeddings of item listings. One example NLP model 226 that can be employed by NLP engine 212 includes bidirectional encoder representations from transformers (BERT). In an aspect, BERT is a pre-trained deep bidirectional representations from unlabeled text via joint conditioning on both left and right context in all layers. A pre-trained BERT model may be fine-tuned using one or more additional output layers. In some embodiments, BERT is pre-trained for sentence-level tasks, such as letter or word inferring or paraphrasing. In some embodiments, BERT predicts a relationship between or among item listing titles by analyzing the titles holistically. In some embodiments, BERT predicts a relationship between or among item listing descriptions (or portions thereof) by analyzing the descriptions (or portions thereof) holistically. In some embodiments, BERT provides a fine-grained output at the token level for one or more item listing titles or for one or more item listing descriptions. During pre-training, BERT may learn general language representations associated with item listing titles or item listing descriptions.

In some embodiments, BERT is pre-trained and then fine-tuned. For example, during pre-training, BERT may be trained on a plain text corpus to identify context for a given word. Continuing the example, BERT may then be fine-tuned using the item listing dataset 222 to determine a text embedding for a given text string. In some embodiments, the pre-training and fine-tuning result in BERT being configured to receive an input token sequence comprising a text string or a plurality of text strings. In some embodiments, the input token sequence may be associated with a <text string, category> token sequence, for example.

It will be understood that other natural language processing models may be used, including one or more models for generating text embeddings from items, item listings, item listing titles, and item listing descriptions, and such models are intended to be within the scope of the natural language processing models described herein. For instance, another suitable example is word2vec.

Once trained, NLP engine 212 can process item listing dataset 222 to identify text embeddings for other text inputs. Item listing data (e.g., an item listing title, a portion of an item listing title, an item listing description, a text string of the item listing description) is provided as an input to the trained NLP model 226 of NLP engine 212. The output provided by the trained NLP model 226 includes one or more text embeddings. The text embedding may include numerical data describing the input in the vector space.

For example, an item listing or a document within the item listing may include a seller identifier and a brand of a shoe item. Continuing the example, text within the item listing or a document associated with the seller identifier or brand can be associated with metadata or can be indexed to indicate that the text represents the brand. In aspects, the metadata or index may indicate that the item listing is associated with a particular category for taxation corresponding to a particular geographical area. That is, text within the item listing or a document associated with an item listing title or item listing description can be identified as associated with a particular tax based on a context of the textual data of the item listing. Text corresponding to a particular category can be associated with metadata or an index to indicate the relationship to the item with the particular category. In an embodiment, the category for taxation associated with the item listing was provided by a user during an item upload process, and such taxation category is associated with the item listing when indexed.

In some embodiments, a category prediction model can be employed to identify a language context for identifying a category within the text of an item listing. The language context may indicate that a particular text string is associated with a particular category that is related to a particular tax corresponding to a particular geographical area. The language context of the item listing title or item listing description may be related to the particular category. The language context of the item listing title or item listing description can be indicated using metadata. In addition, the language context of the item listing title or item listing description can be indicated within the index.

In some embodiments, upon receipt of the item listing 202 by the tax category prediction engine 210, image processing engine 214 may process the item listing 202 to identify or extract image data. The image processing engine 214 may receive one or more item listing images from the item listing 202. The image processing engine 214 may process the one or more item listing images as needed, and store the processed item listing images (e.g., stored within the item listing dataset 222) in data store 220. The item listing image may be received from an entity, such as a third-party seller, a consumer, one or more online marketplaces, a manufacturer, a retailer, a collector, an item expert, a website, another entity, or a combination thereof.

The image processing engine 214 can be applied to process one or more images of the item listing 202. An item listing dataset 222 comprising image data is generated for training the image processing model 228. For example, the item listing image dataset may be generated by extracting item listing images from a plurality of item listings. The image processing engine 214 may be applied to an extracted image for generating an image embedding for the item listing image dataset. For example, the image processing engine 214 may label images from item listings stored at data store 220 and generate the image embeddings for the item listing image dataset using the stored labeled images. In some embodiments, the image processing engine 214 employs optical character recognition (OCR) to process one or more images associated with an item listing to identify item listing description data (e.g., product information, such as brand, make, model, style, serial number, etc.). In some aspects, the images may be labeled based on applying the OCR.

In some embodiments, the item listing image dataset may include directional object boundaries and object classes for objects within images of the item listing image dataset. The directional object boundaries and object classes for objects may be used to label the images and generate the image embeddings. In some embodiments, the item listing image dataset may be labeled using an annotation tool for labeling shapes of objects within the images of the item listing image dataset. In some embodiments, three-dimensional images of the item listing image dataset may be labeled using an end-to-end neural network for identifying boundaries of recognized objects within the three-dimensional images. In some embodiments, the item listing image dataset may be labeled using a frame restoration tool for images having a blurry fame. In some embodiments, the item listing image dataset may be labeled using an algorithm that identifies real-world objects within an image from other parts of the image by dividing the image into parts. In some embodiments, the item listing image dataset may be labeled using a proximity tool for identifying how close an object in the image was to the image sensor when the image was captured by an image capturing device. In some embodiments, a sequence of convolutional neural networks may be used on a plurality of images for one item listing to label an object within the plurality of images based on different views of the object within the plurality of images.

The image processing engine 214 employs the image processing model 228 to process the labeled images within the item listing image dataset. An example image processing model 228 that can be employed by image processing engine 214 includes a deep learning neural network. The image processing model 228 may be trained using organized item listing image datasets. For example, the item listing image datasets may be ordered based on a category (e.g., automatic vehicles, jewelry) associated with the labeled images stored in data store 220. Additionally or alternatively, the item listing image datasets may be organized based on a recall number associated with the respective item listing, a number of purchases associated with the respective item listing, a purchaser-provided ranking of the respective item listing, a number of views of the respective item listing, an amount of taxes paid by the purchasers of the respective item listing, another item listing indictor, or a combination thereof. Further, the trained image processing model 228 may be fine-tuned based on performance metrics subsequent to training and based on feedback. Accordingly, the trained image processing model 228 may generate an image embedding, representing the image in the vector space, upon receiving a first item listing having at least one image.

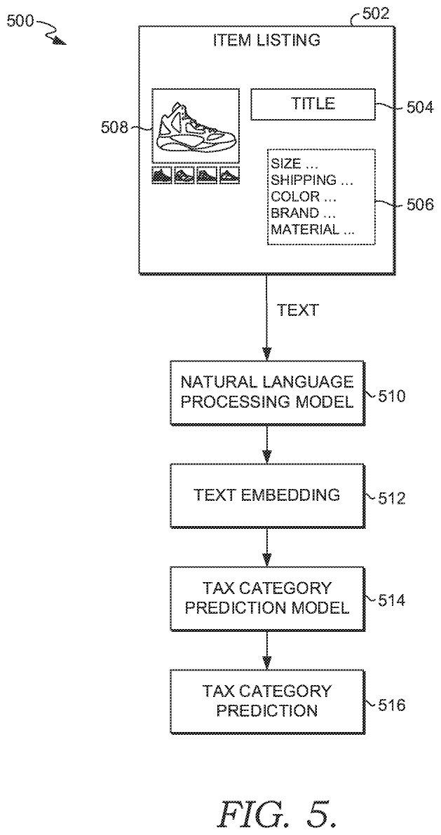

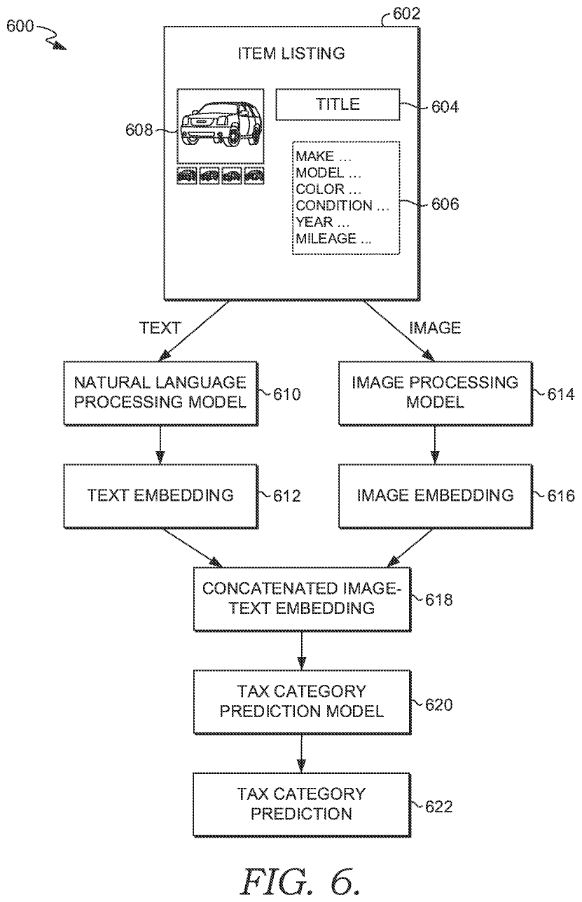

At a high level, the item listing dataset 222 can be in the form of audio, images, video, text, machine language, latent information, text embeddings, image embeddings, another form, or a combination thereof. Image and textual data of the item listing dataset 222 may be obtained or received and stored in the data store 220. In some embodiments, item listing dataset 222 can comprise a combination of an image embedding and a text embedding, which is described in further detail with respect to FIGS. 5 and 6.

While illustrated as separate models, in an aspect, natural language processing model 226 and image processing model 228 are part of a single model used to generate an embedded vector representation of a text string or image.

Mapping component 216 maps the text embedding (e.g., a text embedding generated using OCR to process an image for an item listing to identify an aspect of an item), identified by NLP engine 212, for the item listing 202 to one or more predetermined tax categories to generate a tax category prediction dataset 224 stored at data store 220. The predetermined tax categories, for example, may be associated with a particular geographical area (e.g., a state, a U.S. territory, a county, a particular country or province within that country, a particular city within a country, etc.). The predetermined tax categories, for example, may include educational toys, home office supplies, packaging material, website expenses, communication tools, internet hardware, educational books, grooming products, cleaning products, bedroom furniture, office furniture, fiction books, other predetermined tax categories, or a combination thereof.

Mapping component 216 may also map the image embedding, identified by image processing engine 214, for the item listing 202 to the one or more predetermined tax categories to generate the tax category prediction dataset 224 stored at data store 220. In some embodiments, the tax category prediction dataset 224 comprises text embeddings or image embeddings. In some embodiments, the tax category prediction dataset 224 comprises both text embeddings and image embeddings. In some embodiments, the mapping component 216 remaps the tax category prediction dataset 224 based on a change to the tax category prediction dataset 224 (e.g., an additional item listing received or a change to an item listing stored at data store 220). In some embodiments, the mapping component 216 maps a first subset of the tax category prediction dataset 224 to a first subset of the one or more predetermined tax categories (e.g., the first subset of the one or more predetermined tax categories being above a threshold value associated with the most commonly used tax categories for a particular seller or geographic area).

In some embodiments, the tax category prediction dataset 224 is generated based on a hierarchy of predetermined tax categories. In some embodiments, the tax category prediction dataset 224 is generated for a particular geographical area (e.g., a state, a U.S. territory, a county, a particular country or province within that country, a particular city within a country, etc.). In some embodiments, the tax category prediction dataset 224 is updated based on a change to a corresponding tax scheme for the particular geographical area. In some embodiments, the tax category prediction dataset 224 is ordered alphabetically based on the predetermined tax categories. In some embodiments, the text embedding is concatenated with the image embedding, and the resulting concatenated image-text embedding is included within the tax category prediction dataset.

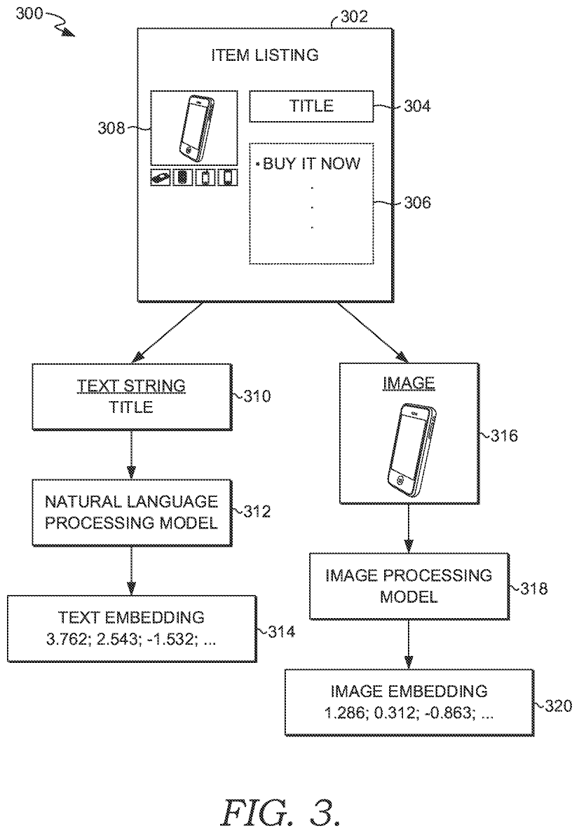

Turning to FIG. 3, example process 300 provides an example embodiment corresponding to NLP engine 212 receiving a text string, and image processing engine 214 receiving an image, from item listing dataset 222 for generating a tax category prediction dataset 224 (e.g., from a text embedding and an image embedding). For example, example process 300 for determining a text embedding and an image embedding for generating the tax category prediction dataset 224 may begin with item listing 302 (e.g., an item listing for a cell phone or a cell phone cover). Item listing 302 is illustrated as including an item listing title 304, an item listing description 306 (e.g., a description of a cell phone item or a cell phone cover item, such as a brand or model, a style, a color, camera specifications, memory specifications, and so forth), and item listing image 308. In some embodiments, the item listing 302 includes a plurality of item listing images. The item listing images may provide different viewpoints of the cell phone item or the cell phone cover item, for example. In some embodiments, the item listing images include the item in different colors, patterns, styles, or sizes. In some embodiments, an item listing video is provided.

From item listing 302, a text string 310 is extracted. The text string 310 may be any text extract from item listing 302. However, as illustrated, text string 310 is a title 304 of the item listing 302. For example, the text string 310 is extracted for receipt by NLP model at block 312. In some embodiments, the text string may be associated with the item listing title 304 (or a portion thereof), the item listing description 306 (or a portion thereof), or a combination of the item listing title 304 and the item listing description 306. The text string may comprise a plurality of characters (e.g., one or more words, an alphanumerical, a plurality of numbers, etc.) for the NLP at block 312 to process. The text string may include more than one language.

At block 312, the NLP model is applied to the text string. The NLP model may be the NLP model 226 of FIG. 2, for example. The NLP model may be trained on an item listing dataset of an item listing database (e.g., item listing dataset 222 of FIG. 2). For example, the NLP model may be trained using a dataset of historical item listings having text strings previously identified within the title or description of the historical item listings. The previously identified text strings of the historical item listings may correspond to a particular category (e.g., a certain tax category for a product, the certain tax category associated with a particular geographical region).

Based on applying the NLP model to the text string at block 312, the NLP model may identify a text embedding at block 314. The text embedding may correspond to the meaning of the word or identifier of the text string in relation to a context of the word or identifier, for example. In addition, the text embedding may represent a value for a vector for a vector space, the text embedding having a plurality of dimensions. In some embodiments, the text string is a representation of how the word or identifier of the text string is used relative to other words or identifiers having similar representations. The other words or identifiers, from which the context of the text string is relative to, may be derived from a text corpus of the historical item listings.

At block 316, image data associated with the item listing image 308, for example, is extracted for receipt by image processing model at block 318. The image data may be associated with an image file (e.g., JPEG, PDF, etc.). The image data may include directional object boundaries and object classes for objects within images. Continuing the example, one or more objects within the image may be labeled based on a directional object boundary and an object class. In some embodiments, an algorithm may be used to identify an object within the image based on dividing the image into parts. Continuing the example, the object, identified based on dividing the image into parts, may be labeled based on a particular feature identified within one of the parts. In some embodiments, an object in an image may be labeled using a proximity tool that identifies a distance between the object and the image sensor used to capture the image of the object.

At block 318, the image processing model is applied to the image data associated with the item listing image 308. The image processing model may be the image processing model 228 of FIG. 2, for example. The image processing model may be trained on an item listing dataset of an item listing database. For example, the image processing model may be trained using a dataset of historical item listings having images previously identified within the historical item listings. The previously identified images of the historical item listings may correspond to a particular category (e.g., a certain tax category for a product, the certain tax category associated with a particular geographical region). Each of the previously identified images may include an object within each of the images that was identified using one or more of an algorithm, directional object boundaries, object classes, a proximity tool, another object identifier tool, or a combination thereof.

Based on applying the image processing model to the image at block 318, the image processing model may identify an image embedding at block 320. The image embedding may correspond to the meaning of the object or a feature of the object within the image in relation to the corresponding item listing description, for example. In some embodiments, the image embedding may represent a value for a vector for a predefined vector space, the image embedding having a plurality of dimensions. In some embodiments, the image embedding is a representation of how the object within the image is used relative to other objects within other images having similar representations. In some embodiments, the image embedding is a representation of how a feature of the object within the image is used relative to other features of other objects within other images having similar representations.

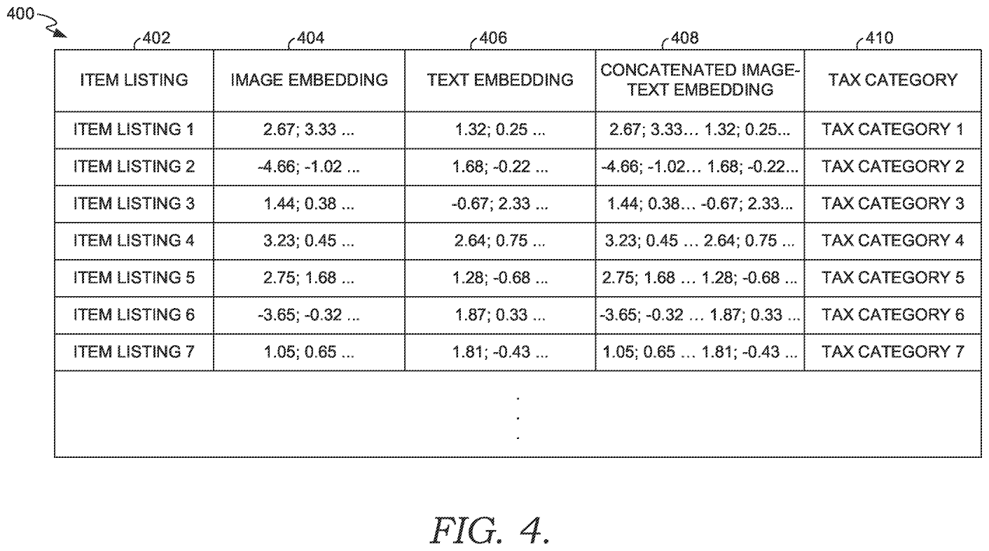

As such, a tax category prediction dataset 224 may be generated from a text embedding, an image embedding, or a combination thereof. For example, in some embodiments, the tax category prediction dataset 224 of FIG. 2 may be generated by concatenating an image embedding and a text embedding. FIG. 4 provides an example embodiment of the tax category prediction dataset 224 generated using a concatenated image-text embedding.

For example, FIG. 4 depicts an example table 400 including an example mapping of a concatenated image-text embedding to a predetermined tax category for generating the tax category prediction dataset. Column 402 of example table 400 includes a plurality of item listings. Column 404 includes an image embedding (e.g., determined using image processing model 228 of FIG. 2 or image processing model 318 of FIG. 3) for each item listing in column 402. In some embodiments, each item listing of column 402 has a plurality of image embeddings. In addition, column 406 includes a text embedding (e.g., determined using NPL model 226 of FIG. 2 or NLP model 312 of FIG. 3) for each item listing. In some embodiments, each item listing of column 402 has a plurality of text embeddings.

Additionally, column 408 includes a concatenated image-text embedding for each item listing. In some embodiments, each item listing has a plurality of concatenated image-text embeddings (e.g., from combining at least one of the plurality of text embeddings with at least one of the plurality of image embeddings for each item listing). The concatenated image-text embedding for each item listing may be used to generate the tax category prediction dataset 224. In some embodiments, a subset of the plurality of concatenated image-text embeddings for each item listing are used to generate the tax category prediction dataset 224. In some embodiments, a subset of the item listings in example table 400 are identified and the concatenated image-text embeddings for the subset of item listings are used to generate the tax category prediction dataset 224.

Further, column 410 includes a tax category for each item listing, image embedding, text embedding, and concatenated image-text embedding. In some embodiments, a single image embedding, text embedding, or concatenated image-text embedding is associated with two or more tax categories (e.g., each of the two or more tax categories associated with a particular geographical region). The tax category can be manually determined. An example is that a user labels the item listing with the tax category during an item upload process. In embodiments, the concatenated image-text embeddings are mapped to the manually determined tax category for generating the tax category prediction dataset 224.

Returning to FIG. 2, the tax category prediction model trainer 218 may train the tax category prediction model 230 using the tax category prediction dataset 224. The tax category prediction model 230 may be trained to identify the similarity between a text embedding, an image embedding, or a combination of the image and text embedding, and a predetermined tax category. The tax category prediction model 230, for example, may be a machine learning model or may be employed by another type of logical computing structure, such as a decision tree, a support vector machine, a Bayesian network, etc. As another example, the trained tax category prediction model 230 may be based on deep neural networks (having multiple hidden layers of units between input and output layers) or convolutional neural networks (having one or more convolution layers with fully connected layers for using tied weights and for pooling layers).

In some embodiments, the tax category prediction model 230 is trained using the tax category prediction dataset 224, such that the tax category prediction model 230 can identify which vector representation for the predetermined tax categories has a closest distance to another vector generated from an input of an image embedding, a text embedding, or a combination thereof. For example, the tax category prediction model 230 can determine that a vector generated for an item listing for a poster having images and words related to an alcoholic beverage has a closest distance to vector representation for a predetermined tax category associated with the item listing being a poster. Conversely, the prior systems might determine that the item listing, for the poster having the words related to the alcoholic beverage, is associated with an alcoholic beverage.

In response to training the tax category prediction model 230, the tax category prediction model 230 may receive one or more text embeddings for one or more item listings, each of the one or more item listings corresponding to an item. Based on receiving the one or more text embeddings, the tax category prediction model 230 may provide an output for predicting a tax category for the first item listing. For example, the tax category prediction model 230 can determine that a vector generated for an item listing description or title for a cleaning product comprising an alcohol has a closest distance to vector representation for a predetermined tax category associated with the item listing being a cleaning product. Conversely, the prior systems might determine that the item listing, for the cleaning product comprising an alcohol, is associated with an alcoholic beverage.

Additionally or alternatively, in response to training the tax category prediction model 230, the tax category prediction model 230 may receive one or more image embeddings for one or more item listings, each of the one or more item listings corresponding to an item. Based on receiving the one or more image embeddings, the tax category prediction model 230 may provide an output for a tax category prediction 240 for the first item listing. Further, in response to training the tax category prediction model 230, the tax category prediction model 230 may receive an image-text embedding for an item listing corresponding to an item. Based on receiving the image-text embedding, the tax category prediction model 230 may provide an output for the tax category prediction 240 for the first item listing. In an example, the image embedding (determined from an image of an item listing) is provided to the tax category prediction model 230, which outputs the predicted tax category in response. In another example, a concatenated image-text embedding (determined from a text string and an image of an item listing) is provided to the tax category prediction model, which outputs the predicted tax category in response.

In some embodiments, an instruction is transmitted to a user device to display a graphical user interface including a price associated with the tax category prediction 240 for the first item. For example, the user device may be associated with a seller, and the instruction may be transmitted prior to the item listing being offered on the online marketplace. In some embodiments, the user device is computing device 800 described in FIG. 8. In some embodiments, the user device is associated with a user or administrator of the online marketplace. The price may correspond to a particular geographical region. The price may be provided in one or more currencies.

FIG. 5 depicts example flow diagram 500 illustrating an example method for providing a tax category prediction for an item listing. Example item listing 502 comprises an item listing title 504, an item listing description 506 (e.g., comprising a description of the shoe item, such as a size, shipping costs or shipping options, estimated shipping dates, one or more colors or patterns associated with the shoe item, the brand of the shoe item, the material of the shoe item, or other description data), and an item listing image 508. In some embodiments, the item listing 502 comprises a plurality of item listing images. The item listing images may include different views of the shoe item in each image, three-dimensional images of the shoe item, a video of the shoe item, or different styles of the shoe item (e.g., in different colors or with different materials).

At 510, a natural language processing model (e.g., NLP model 226 of FIG. 2) receives text from the item listing 502. For example, the text may be received from the item listing title 504, the item listing description 506, or a combination thereof. In some embodiments, the text received by the natural language processing model comprises a portion of the item listing title 504 and a portion of the item listing description 506. In some embodiments, the text is in one or more languages. In some embodiments, the text comprises one or more symbols. In some embodiments, the natural language processing model comprises bidirectional encoder representations from transformers (BERT). In some embodiments, BERT is trained using one or more unidirectional models.

Based on receiving the text at 510, the natural language processing model identifies a text embedding for the text from the item listing 502 at 512. In some embodiments, text embeddings identified for historical item listings are mapped to one or more predetermined tax categories to generate a tax category prediction dataset. The tax category prediction dataset is used to train the tax category prediction model. In some embodiments, one or more tax category prediction datasets are generated using text embeddings from one or more portions of item listing titles of the historical item listings. In some embodiments, one or more tax category prediction datasets are generated using text embeddings from one or more portions of item listing descriptions of the historical item listings. In some embodiments, one or more tax category prediction datasets are generated using (1) the text embeddings from one or more portions of item listing titles of the historical item listings and (2) the text embeddings from the one or more portions of item listing descriptions of the historical item listings.

At 516, the trained tax category prediction model receives the text embedding for the text from the item listing 502. At 518, the trained tax category prediction model provides a tax category prediction for the first item listing based on receiving the first text embedding. In some aspects, instruction is transmitted to a user device to display a graphical user interface including the tax category prediction for the first item. In some aspects, the instruction is to display the graphical user interface additionally including a price associated with the tax category prediction for the first item. In some embodiments, the instruction is to display the graphical user interface including a plurality of tax category predictions with an associated percentage or ranking of the plurality of tax category predictions for the first item listing.

In some embodiments, a change from the tax category prediction to another tax category for the first item of the first item listing is received (e.g., a user-selected change). Based on the change received, the first text embedding of the first item listing is mapped to the other tax category for the first item. The tax category prediction dataset is regenerated based on the mapping to the other tax category, and the tax category prediction model is retrained based on the regenerated tax category prediction dataset. Accordingly, the retrained tax category prediction model may receive a second text embedding of a second text string from a second item listing for a second item. As such, the tax category prediction model provides a second tax category prediction for the second item listing based on the second text embedding.

In some embodiments, the tax category prediction model is further generated by receiving an image embedding generated for each of a plurality of item listings. Additionally, the generated image embeddings may be mapped to one or more predetermined tax categories to further generate the tax category prediction dataset. Accordingly, the tax category prediction model may be trained using the tax category prediction dataset having the text embeddings mapped to the one or more predetermined tax categories and the image embeddings mapped to the one or more predetermined tax categories. Upon receiving a first text embedding and a first image embedding for a first item listing of a first item (the first item listing comprising a first text string and a first image), the tax category prediction model may provide the first tax category prediction for the first item listing. In some embodiments, the tax category prediction model may provide a second tax category prediction for a second item listing based on receiving a second image embedding for the second item listing. In some embodiments, the tax category prediction model may provide a third tax category prediction for a third item listing based on receiving two text embeddings for the third item listing.

FIG. 6 depicts another example flow diagram 600 illustrating an example method for providing a tax category prediction for an item listing. Example item listing 602 comprises an item listing title 604, an item listing description 606 (e.g., comprising a description of the vehicle item, such as a make and model, condition (e.g., new or used), a year, one or more colors or patterns associated with the vehicle item, the manufacturer of the vehicle item, the mileage of the vehicle item, or other description data), and one or more item listing images or videos 608.

At 610, a natural language processing model (e.g., NLP model 226 of FIG. 2) receives text from the item listing 602. In some embodiments, text embeddings identified for a plurality of item listings are mapped to one or more predetermined tax categories to generate a tax category prediction dataset. The tax category prediction dataset is used to train the tax category prediction model. Based on receiving the text at 610, the trained natural language processing model identifies a text embedding for the text at 612.

At 614, an image processing model (e.g., image processing model 228 of FIG. 2) receives item listing image 608 from the item listing 602. The image processing model may be trained using a plurality of item listing images identified for item listings having a known predetermined tax category. The plurality of item listing images may be labeled, for training the image processing model, by using object identification techniques. Based on receiving the item listing image 608 at 614, the trained image processing model identifies an image embedding for the text of item listing 602 at 616.

At 618, the text embedding and the image embedding for the item listing 602 are concatenated to generate a concatenated image-text embedding. A plurality of concatenated image-text embeddings may be generated for a plurality of item listing images identified for item listings having a known predetermined tax category. For example, each of the plurality of concatenated image-text embeddings may be generated using one or more text embeddings and one or more image embeddings of a particular item listing having a known predetermined tax category. As such, each of the concatenated image-text embeddings may be mapped to one or more predetermined tax categories to generate a tax category prediction dataset. The generated tax category prediction dataset is used to train the tax category prediction model (e.g., the tax category prediction model 230 of FIG. 2).

At 620, the trained tax category prediction model receives a first text embedding and a first image embedding for item listing 602. Based on receiving the first text embedding and the first image embedding, the trained tax category prediction model provides a tax category prediction for the item listing 602 at 622. In some embodiments, the trained tax category prediction model receives a first concatenated image-text embedding for item listing 602 and subsequently provides a tax category prediction for the item listing 602 at 622.

In embodiments, the tax category prediction model is retrained in response to receiving a change from the tax category prediction to another tax category prediction for the first item of the first item listing. For example, the tax category prediction dataset may be updated based on mapping the first text embedding of the first item listing to the other tax category for the first item. In some embodiments, the tax category prediction dataset is updated based on mapping the first image embedding to the other tax category for the first item. In some embodiments, the tax category prediction dataset is updated based on mapping a concatenated image-text embedding of the first item listing to the other tax category.

Accordingly, the tax category prediction model is retrained based on updating the tax category prediction dataset in response to receiving the change. In response to retraining the tax category prediction model, the tax category prediction model receives a second text embedding of a second text string from a second item listing for a second item and subsequently provides a second tax category prediction for the second item listing based on the second text embedding. In some embodiments, in response to retraining the tax category prediction model, the tax category prediction model receives a second image embedding of a second image from the second item listing in addition to the second text embedding and subsequently provides the second tax category prediction. In yet another embodiment, in response to retraining the tax category prediction model, the tax category prediction model receives the second image embedding of the second image from the second item listing and subsequently provides the second tax category prediction based on the second image embedding.

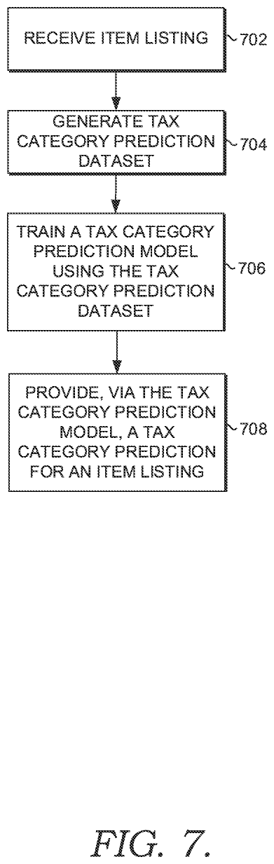

FIG. 7 depicts flow diagram 700. At 702, an item listing for an item is received. The item listing may comprises a text string (e.g., from a title of the item listing or a description of the item listing). In some embodiments, the item listing comprises one or more images for an item of the item listing.

At 704, a tax category prediction dataset is generated. For example, a natural language processing model may be applied to the text string identified within the item listing to identify a text embedding for generating tax category prediction dataset. The natural language processing model may be trained on an item listing dataset of an item listing database. In some embodiments, an image embedding is identified from the item listing by applying an image processing model to one or more images of the item listing. The image processing model may be trained on an item listing dataset of an item listing database. In some embodiments, the text embedding and the image embedding of an item listing are concatenated to generate a concatenated image-text listing. The tax category prediction dataset may be generated by mapping the text embedding, the image embedding, or the concatenated image-text embedding to one or more predetermined tax categories.

At 706, a tax category prediction model is trained using the tax category prediction dataset. At 708, the trained tax category prediction model receives a first text embedding from a first item listing of a first item provides a tax category prediction for the first item listing based on the first text embedding. In some embodiments, the trained tax category prediction model receives a first image embedding from the first item listing and provides the tax category prediction based on the first image embedding. In some embodiments, the trained tax category prediction model provides the tax category prediction based on the first image embedding and the first text embedding.

Having described an overview of embodiments of the present technology, an example operating environment in which embodiments of the present technology may be implemented is described below in order to provide a general context for various aspects. Referring initially to FIG. 8, in particular, an example operating environment for implementing embodiments of the present technology is shown and designated generally as computing device 800. Computing device 800 is but one example of a suitable computing environment and is not intended to suggest any limitation as to the scope of use or functionality of the technology. Neither should computing device 800 be interpreted as having any dependency or requirement relating to any one or combination of components illustrated.

The technology of the present disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 802 that directly or indirectly couples the following devices: memory 804, one or more processors 806, one or more presentation components 808, input/output ports 810, input/output components 812, and illustrative power supply 814. Bus 802 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component, such as a display device, to be an I/O component. As another example, processors may also have memory. Such is the nature of the art, and it is again reiterated that the diagram of FIG. 8 is merely illustrates an example computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, and removable and non-removable media. By way of example, and not limitation, computer-readable media may comprise computer storage media and communication media.

Computer storage media include volatile and nonvolatile, removable and non-removable media implemented in any method or technology for storage of information, such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 804 includes computer storage media in the form of volatile or nonvolatile memory. The memory 804 may be removable, non-removable, or a combination thereof. Example hardware devices include solid-state memory, hard drives, optical-disc drives, etc. Computing device 800 includes one or more processors that read data from various entities such as memory 804 or I/O components 812. Presentation component(s) 808 present data indications to a user or other device. Examples of presentation components include a display device, speaker, printing component, vibrating component, etc.

I/O ports 810 allow computing device 800 to be logically coupled to other devices including I/O components 812, some of which may be built in. Illustrative components include a microphone, joystick, game pad, satellite dish, scanner, printer, wireless device, and so forth.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including” or “having” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

For purposes of a detailed discussion above, embodiments of the present technology described with reference to a distributed computing environment; however, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the described schematics, it is understood that the techniques described may be extended to other implementation contexts.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated the accompanying drawings is to be interpreted as illustrative and not in a limiting sense.

Some example aspects of the technology that may be practiced from the forgoing disclosure include the following:
Aspect 1: A computer-implemented method comprising: receiving an item listing for an item, the item listing comprising a text string; applying a natural language processing model to the text string to identify a text embedding, the natural language processing model trained on an item listing dataset of an item listing database; mapping the text embedding identified for the item listing to one or more predetermined tax categories to generate a tax category prediction dataset; training a tax category prediction model using the tax category prediction dataset; receiving, by the trained tax category prediction model, a first text embedding from a first item listing of a first item; and providing, by the trained tax category prediction model, a tax category prediction for the first item listing based on the first text embedding.
Aspect 2: Aspect 1, wherein the text string is a title of the item listing for the item.
Aspect 3: Aspect 1 or 2, wherein the natural language processing model comprises bidirectional encoder representations from transformers (BERT).
Aspect 4: Aspect 1, 2, or 3, further comprising: generating an image embedding for an image of the item listing; concatenating the image embedding with the text embedding for the item listing; mapping the concatenated image-text embedding to the one or more predetermined tax categories to further generate the tax category prediction dataset, wherein the tax category prediction model is trained on the tax category prediction dataset comprising the concatenated image-text embedding mapped to the one or more predetermined tax categories; receiving, by the trained tax category prediction model, the first text embedding and a first image embedding of a first image from the first item listing; and providing, by the trained tax category prediction model, the tax category prediction for the first item listing based on receiving the first text embedding and the first image embedding.
Aspect 5: Aspect 1, 2, 3, or 4, further comprising: transmitting an instruction to a user device to display a graphical user interface including a price associated with the tax category prediction for the first item.
Aspect 6: Aspect 1, 2, 3, 4, or 5, further comprising: receiving a change from the tax category prediction to another tax category for the first item of the first item listing; retraining the tax category prediction model based on a mapping of the first text embedding of the first item listing to the other tax category for the first item; receiving, by the retrained tax category prediction model, a second text embedding of a second text string from a second item listing for a second item; and providing, by the retrained tax category prediction model, a second tax category prediction for the second item listing based on the second text embedding.
Aspect 7: Aspect 6, wherein the tax category prediction dataset for training the tax category prediction model further comprises an image-text embedding mapped to the one or more predetermined tax categories, the image-text embedding determined by concatenating the text embedding with an image embedding for an image of the item listing, and wherein the tax category prediction model is retrained based on the image-text embedding being mapped to the another tax category, the method further comprising: receiving, by the retrained tax category prediction model, a second image embedding of a second image from the second item listing in addition to the second text embedding; and providing, by the retrained tax category prediction model, the second tax category prediction for the second item listing based on the second image embedding and the second text embedding.
Aspect 8: One or more computer storage media storing computer-useable instructions that, when used by a computing device, cause the computing device to perform operations, the operations comprising: receiving a plurality of item listings for one or more items, each of the plurality of item listings comprising a text string; generating a tax category prediction model by: identifying a text embedding within each of the plurality of item listings using a natural language processing model, the natural language processing model trained on an item listing dataset of an item listing database; mapping the text embedding identified for each of the plurality of item listings to one or more predetermined tax categories; and generating a tax category prediction dataset based on mapping the text embedding identified for each of the plurality of item listings to the one or more predetermined tax categories; and training the tax category prediction model using the tax category prediction dataset, to generate a trained tax category prediction model configured to receive a first text embedding from a first item listing of a first item and output a tax category prediction for the first item listing.
Aspect 9: Aspect 8, the operations further comprising: receiving, by the trained tax category prediction model, the first text embedding from the first item listing of the first item; and providing the tax category prediction for the first item listing based on the trained tax category prediction model receiving the first text embedding.
Aspect 10: Aspect 8 or 9, wherein the tax category prediction model is further generated by: receiving an image embedding generated for each of the plurality of item listings; mapping the image embedding for each of the plurality of item listings to the one or more predetermined tax categories to further generate the tax category prediction dataset; and generating the tax category prediction dataset further based on mapping the image embedding to the one or more predetermined tax categories.
Aspect 11: Aspect 10, the operations further comprising: receiving, by the trained tax category prediction model, the first text embedding and a first image embedding for the first item listing of the first item comprising the text string and a first image; and providing the tax category prediction for the first item listing based on the trained tax category prediction model receiving the first text embedding and the first image embedding.
Aspect 12: Aspect 8 or 9, wherein the tax category prediction model is further generated by: receiving an image embedding generated for each of the plurality of item listings; concatenating the image embedding for each of the plurality of item listings with the text embedding identified for each of the plurality of item listings; and mapping the concatenated image-text embedding to the one or more predetermined tax categories to further generate the tax category prediction dataset, wherein the tax category prediction model is trained on the tax category prediction dataset comprising the concatenated image-text embedding to the one or more predetermined tax categories.
Aspect 13: Aspect 12, the operations further comprising: receiving, by the trained tax category prediction model, the first text embedding and the first image embedding for the first item listing of the first item comprising the text string and a first image; and providing a tax category prediction for the first item listing based on the trained tax category prediction model receiving the first text embedding and the first image embedding.
Aspect 14: Aspect 8, 9, 10, 11, 12, or 13, wherein the text string is a title of the first item listing for the first item.
Aspect 15: Aspect 8, 9, 10, 11, 12, 13, or 14, wherein the natural language processing model comprises bidirectional encoder representations from transformers (BERT).
Aspect 16: A computer system comprising: a processor; and a computer storage medium storing computer-useable instructions that, when used by the processor, causes the computer system to perform operations comprising: receiving an item listing for an item, the item listing comprising a text string; identifying a text embedding by applying a natural language processing model to the text string, the natural language processing model trained on an item listing dataset; mapping the text embedding to one or more predetermined tax categories to generate a tax category prediction dataset; receiving, by a tax category prediction model that is trained using the tax category prediction dataset, a first text embedding from a first item listing of a first item; and providing a tax category prediction for the first item listing based on the trained tax category prediction model receiving the first text embedding.
Aspect 17: Aspect 16, wherein the tax category prediction dataset for training the tax category prediction model further comprises an image embedding from each of a plurality of item listings, each image embedding mapped to the one or more predetermined tax categories, wherein the first item listing further comprises a first image, and wherein the tax category prediction is provided based on the trained tax category prediction model receiving the first text embedding and the first image embedding.
Aspect 18: Aspect 17, wherein the operations further comprise: receiving, by the trained tax category prediction model, a second image embedding of a second image from a second item listing; and providing a second tax category prediction for the second item listing based on the trained tax category prediction model receiving the second image embedding.
Aspect 19: Aspect 16, 17, 18, or 19, wherein the natural language processing model comprises bidirectional encoder representations from transformers (BERT).
Aspect 20: Aspect 16, 17, 18, 19, or 20, wherein the text string is a title of the item listing and the first text embedding is associated with a first title of the first item listing, and wherein the item listing dataset comprises a plurality of titles for item listings.

What is claimed is:

1. A computer-implemented method comprising:
receiving an item listing for an item, the item listing comprising a text string;
applying a natural language processing model to the text string to identify a text embedding, the natural language processing model trained on an item listing dataset of an item listing database;
mapping the text embedding identified for the item listing to one or more predetermined tax categories to generate a tax category prediction dataset;
training a tax category prediction model using the tax category prediction dataset;
receiving, by the trained tax category prediction model, a first text embedding from a first item listing of a first item; and
providing, by the trained tax category prediction model, a tax category prediction for the first item listing based on the first text embedding.

2. The computer-implemented method of claim 1, wherein the text string is a title of the item listing for the item.

3. The computer-implemented method of claim 1, wherein the natural language processing model comprises bidirectional encoder representations from transformers (BERT).

4. The computer-implemented method of claim 1, further comprising:
generating an image embedding for an image of the item listing;
concatenating the image embedding with the text embedding for the item listing;
mapping the concatenated image-text embedding to the one or more predetermined tax categories to further generate the tax category prediction dataset, wherein the tax category prediction model is trained on the tax category prediction dataset comprising the concatenated image-text embedding mapped to the one or more predetermined tax categories;
receiving, by the trained tax category prediction model, the first text embedding and a first image embedding of a first image from the first item listing; and
providing, by the trained tax category prediction model, the tax category prediction for the first item listing based on receiving the first text embedding and the first image embedding.

5. The computer-implemented method of claim 1, further comprising transmitting an instruction to a user device to display a graphical user interface including a price associated with the tax category prediction for the first item.

6. The computer-implemented method of claim 1, further comprising:
receiving a change from the tax category prediction to another tax category for the first item of the first item listing;
retraining the tax category prediction model based on a mapping of the first text embedding of the first item listing to the other tax category for the first item;
receiving, by the retrained tax category prediction model, a second text embedding of a second text string from a second item listing for a second item; and
providing, by the retrained tax category prediction model, a second tax category prediction for the second item listing based on the second text embedding.

7. The computer-implemented method of claim 6, wherein the tax category prediction dataset for training the tax category prediction model further comprises an image-text embedding mapped to the one or more predetermined tax categories, the image-text embedding determined by concatenating the text embedding with an image embedding for an image of the item listing, and wherein the tax category prediction model is retrained based on the image-text embedding being mapped to the another tax category, the method further comprising:
receiving, by the retrained tax category prediction model, a second image embedding of a second image from the second item listing in addition to the second text embedding; and
providing, by the retrained tax category prediction model, the second tax category prediction for the second item listing based on the second image embedding and the second text embedding.

8. One or more computer storage media storing computer-useable instructions that, when used by a computing device, cause the computing device to perform operations, the operations comprising:
receiving a plurality of item listings for one or more items, each of the plurality of item listings comprising a text string;
generating a tax category prediction model by:
identifying a text embedding within each of the plurality of item listings using a natural language processing model, the natural language processing model trained on an item listing dataset of an item listing database;
mapping the text embedding identified for each of the plurality of item listings to one or more predetermined tax categories; and
generating a tax category prediction dataset based on mapping the text embedding identified for each of the plurality of item listings to the one or more predetermined tax categories; and
training the tax category prediction model using the tax category prediction dataset, to generate a trained tax category prediction model configured to receive a first text embedding from a first item listing of a first item and output a tax category prediction for the first item listing.

9. The one or more computer storage media of claim 8, the operations further comprising:
receiving, by the trained tax category prediction model, the first text embedding from the first item listing of the first item; and
providing the tax category prediction for the first item listing based on the trained tax category prediction model receiving the first text embedding.

10. The one or more computer storage media of claim 8, wherein the tax category prediction model is further generated by:
receiving an image embedding generated for each of the plurality of item listings;
mapping the image embedding for each of the plurality of item listings to the one or more predetermined tax categories to further generate the tax category prediction dataset; and
generating the tax category prediction dataset further based on mapping the image embedding to the one or more predetermined tax categories.

11. The one or more computer storage media of claim 10, the operations further comprising:
receiving, by the trained tax category prediction model, the first text embedding and a first image embedding for the first item listing of the first item comprising the text string and a first image; and
providing the tax category prediction for the first item listing based on the trained tax category prediction model receiving the first text embedding and the first image embedding.

12. The one or more computer storage media of claim 8, wherein the tax category prediction model is further generated by:
receiving an image embedding generated for each of the plurality of item listings;
concatenating the image embedding for each of the plurality of item listings with the text embedding identified for each of the plurality of item listings; and
mapping the concatenated image-text embedding to the one or more predetermined tax categories to further generate the tax category prediction dataset, wherein the tax category prediction model is trained on the tax category prediction dataset comprising the concatenated image-text embedding to the one or more predetermined tax categories.

13. The one or more computer storage media of claim 12, the operations further comprising:
receiving, by the trained tax category prediction model, the first text embedding and the first image embedding for the first item listing of the first item comprising the text string and a first image; and
providing the tax category prediction for the first item listing based on the trained tax category prediction model receiving the first text embedding and the first image embedding.

14. The one or more computer storage media of claim 13, wherein the text string is a title of the first item listing for the first item.

15. The one or more computer storage media of claim 8, wherein the natural language processing model comprises bidirectional encoder representations from transformers (BERT).

16. A computer system comprising:
a processor, and
a computer storage medium storing computer-useable instructions that, when used by the processor, causes the computer system to perform operations comprising:
receiving an item listing for an item, the item listing comprising a text string;
identifying a text embedding by applying a natural language processing model to the text string, the natural language processing model trained on an item listing dataset;
mapping the text embedding to one or more predetermined tax categories to generate a tax category prediction dataset;
receiving, by a tax category prediction model that is trained using the tax category prediction dataset, a first text embedding from a first item listing of a first item; and
providing a tax category prediction for the first item listing based on the trained tax category prediction model receiving the first text embedding.

17. The computer system of claim 16, wherein the tax category prediction dataset for training the tax category prediction model further comprises an image embedding from each of a plurality of item listings, each image embedding mapped to the one or more predetermined tax categories, wherein the first item listing further comprises a first image, and wherein the tax category prediction is provided based on the trained tax category prediction model receiving the first text embedding and the first image embedding.

18. The computer system of claim 17, wherein the operations further comprise:
receiving, by the trained tax category prediction model, a second image embedding of a second image from a second item listing; and
providing a second tax category prediction for the second item listing based on the trained tax category prediction model receiving the second image embedding.

19. The computer system of claim 16, wherein the natural language processing model comprises bidirectional encoder representations from transformers (BERT).

20. The computer system of claim 16, wherein the text string is a title of the item listing and the first text embedding is associated with a first title of the first item listing, and wherein the item listing dataset comprises a plurality of titles for item listings.
